(19) United States
(12) Patent Application Publication
(10) Pub. No.: US 2018/0122133 A1
(43) Pub. Date: May 3, 2018

(54) SYSTEM AND METHOD FOR DISPLAYING INDUSTRIAL ASSET ALARMS IN A VIRTUAL ENVIRONMENT

(71) Applicant: Honeywell International Inc., Morris Plains, NJ (US)

(72) Inventors: Anand Narayan, Bangalore (IN); Murugan Pachaiyappan, Hyderabad (IN)

(21) Appl. No.: 15/338,274

(22) Filed: Oct. 28, 2016

(51) Int. Cl. G06T 17/00; G06T 19/20; G08B 5/22

(52) U.S. Cl. CPC G06T 17/00; G08B 5/22; G06T 19/20

(57) ABSTRACT

An apparatus includes at least one processing device configured to generate a three-dimensional (3D) virtual object corresponding to an industrial asset and map data to the 3D virtual object to generate a virtual representation of the industrial asset. The apparatus also includes a display configured to display the virtual representation. The at least one processing device may be configured to generate the 3D virtual object using at least one image of the industrial asset. The at least one processing device may be configured to generate the virtual representation identifying multiple sub-components of the industrial asset and to map the data to different sub-components of the industrial asset.

### TECHNICAL FIELD

This disclosure relates generally to industrial process control and automation systems. More specifically, this disclosure relates to three-dimensional visualization of industrial assets in a virtual environment.

### BACKGROUND

Industrial process control and automation systems are often used to automate large and complex industrial processes. These types of systems routinely include various industrial assets, such as sensors, actuators, input/output (I/O) modules, and controllers. The controllers typically receive measurements from the sensors through the I/O modules and generate control signals for the actuators.

The various components may trigger an alarm to alert a user of an issue with the component. Users of such systems cannot view the alarm and the corresponding component that triggers the alarm in three-dimensional (3D) virtual environment. Further, the user may not know the assembly and configuration of the component thereby preventing the user from diagnosing and repairing any component hardware issues. Resolving the specific alarm may require a user to refer to a user guide or contact an asset vendor.

### SUMMARY

This disclosure provides systems and methods for three-dimensional visualization of industrial assets in a virtual environment.

In a first embodiment, an apparatus includes at least one processing device configured to generate a three-dimensional (3D) virtual object corresponding to an industrial asset and map data to the 3D virtual object to generate a virtual representation of the industrial asset. The apparatus also includes a display configured to display the virtual representation.

In a second embodiment, a method includes generating a 3D virtual object corresponding to an industrial asset, mapping data to the 3D virtual object to generate a virtual representation of the industrial asset, and displaying the virtual representation on a display.

In a third embodiment, a non-transitory computer readable medium contains computer readable program code that, when executed by at least one processing device, causes the at least one processing device to generate a 3D virtual object corresponding to an industrial asset, map data to the 3D virtual object to generate a virtual representation of the industrial asset, and display the virtual representation.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example device for performing functions associated with three-dimensional visualization of industrial assets in a virtual environment according to this disclosure;

FIG. 3 illustrates an example method for creating a virtual representation of an industrial asset according to this disclosure;

FIG. 4 illustrates an example virtual representation of an industrial asset and its corresponding information according to this disclosure; and

FIG. 5 illustrates an example method for resolving an alarm according to this disclosure.

### DETAILED DESCRIPTION

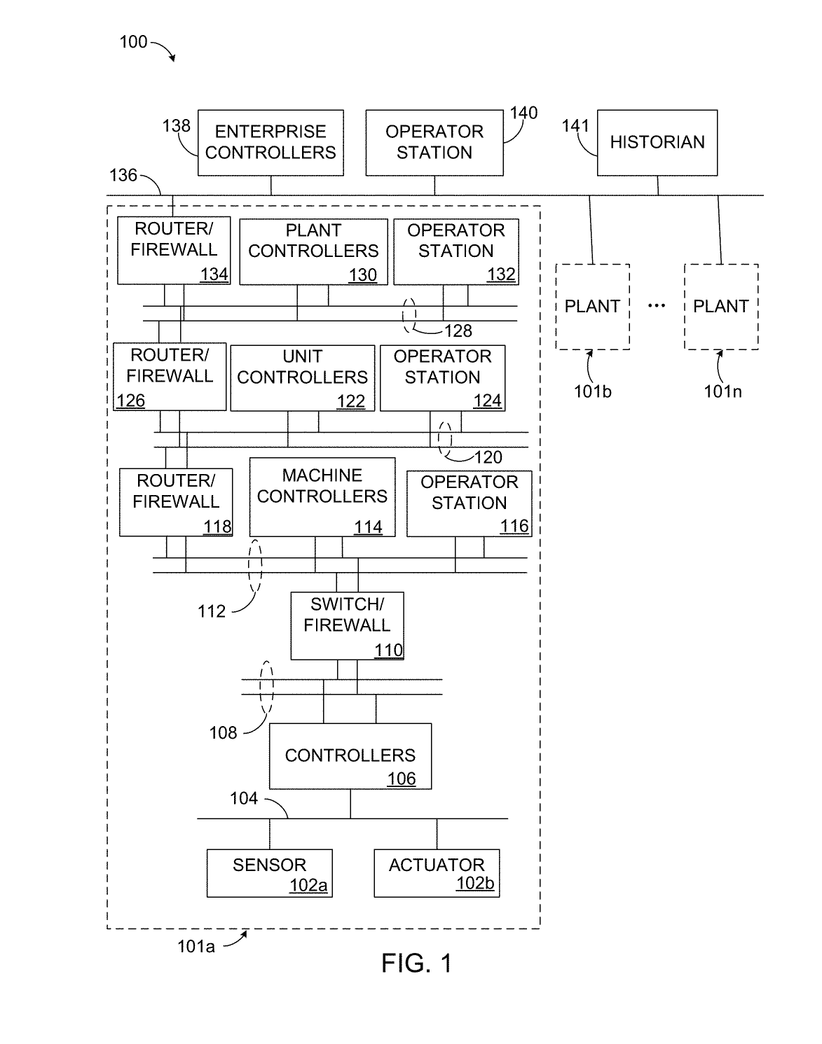

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Current technologies do not permit a user to view industrial asset components and information (such as methods, variables, graphs, charts, etc.) associated with the industrial asset on a display or other user interface. Also, current technologies do not permit asset vendors or users to map alarms and other information to the components in a three-dimensional (3D) virtual environment that could be displayed to the user. As such, when an alarm is triggered in an industrial system, a user cannot view the alarm and the corresponding component that triggers the alarm in a 3D virtual environment. Further, the user may not know the assembly and configuration of the component thereby preventing the user from diagnosing and repairing any component hardware issues. Resolving the specific alarm may require a user to refer to a user guide or contact the asset vendor.

The present disclosure is directed to methods and systems for a 3D visualization of an industrial asset and its components in a personal computer (PC) host or a mobile application. Asset components that are triggering the alarms are displayed and a user may navigate and view the sub-components in detail. The systems permit a user to view information (e.g., user interface programs, charts, graphs, grids, variables, etc.) associated with the sub-components and execute methods for gathering diagnostic information or resolve the alarms in the asset. The user may view media, such as pictures, animations, videos, etc., associated with the asset and its components. The user may also create 3D custom views to visualize the asset components and allow the user to associate information with the asset components.

The methods and systems described here permit identification of asset alarms accurately and permit the user to plan for a solution. The user is able to see the assembly, sub-components, fasteners, etc., and determine the tools that may be used to resolve the issue and components to order. This reduces the cycle time of maintenance activities and allows users to plan for the fixes in the control room itself. The methods and systems permit the user to have an intuitive view of the asset and information associated with the asset's components, thereby improving the user experience; permit understanding of the assembly of the asset; and utilize the modular design of industrial assets to fix components instead of replacing the complete asset. Other features of the disclosed methods and systems include the ability to train field service engineers in steps and tools required to disassemble the asset to replace the component, which can increase their proficiency and efficiency while fixing asset issues; permit the users to attach custom notes to the complex asset parts and components, such as valves, positioners, etc.; permit users to share the 3D virtual models across platforms such as PCs, human machine interface (HMI) displays, mobile devices, etc.; and permit users to create 2D or 3D visualizations for assets that do not include 3D visualizations.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Additionally or alternatively, each controller 122 could represent a multivariable controller, such as a HONEYWELL C300 controller. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS or APPLE iOS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS or APPLE iOS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS or APPLE iOS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS or APPLE iOS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers and operator stations could include one or more processing devices and one or more memories for storing instructions and data used, generated, or collected by the processing device(s). Each of the controllers and operator stations could also include at least one network interface, such as one or more Ethernet interfaces or wireless transceivers.

In accordance with this disclosure, one or more components in the system 100 could be designed or modified to support creation of virtual representations of industrial assets. For example, one or more of the operator stations 116, 124, 132, 140 could be configured for 3D visualization of industrial assets and their components. Further details regarding this functionality are provided below.

Although FIG. 1 illustrates one example of an industrial process control and automation system 100, various changes may be made to FIG. 1. For example, the system 100 could include any number of sensors, actuators, controllers, servers, operator stations, networks, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment in which creation of a virtual representation of an industrial asset is supported. This functionality can be used in any other suitable system, and the system need not be related to industrial process control and automation.

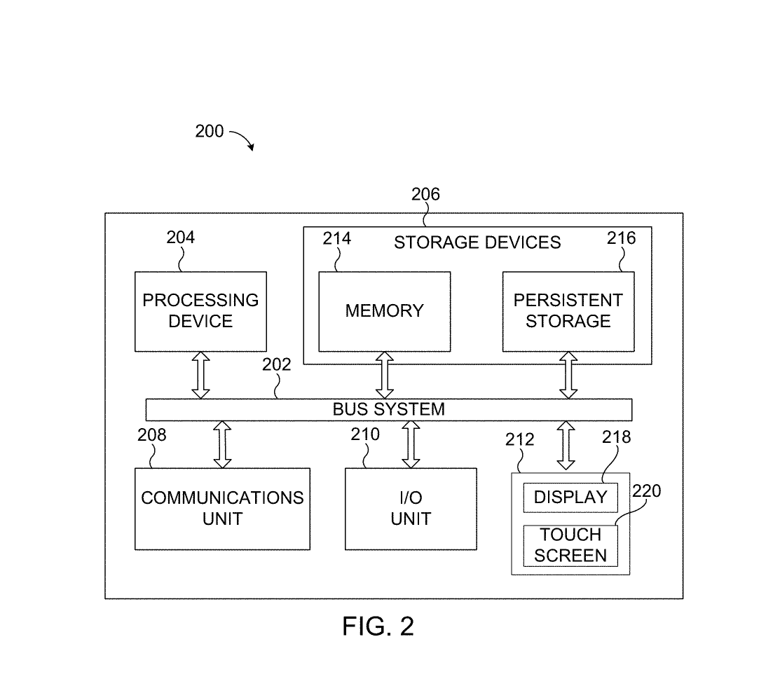

FIG. 2 illustrates an example device 200 for performing functions associated with three-dimensional visualization of industrial assets in a virtual environment according to this disclosure. The device 200 may be a terminal, such as a computer located in a control room. The device 200 may also be a mobile device, such as a tablet, laptop, or smartphone. The device 200 may further represent a wearable device, such as a virtual reality (VR) device or computing glasses (such as GOOGLE GLASSES). The device 200 may operate as any of the operator stations or other devices in the system 100 of FIG. 1 or any device that may operate in conjunction with an operator station or other device in the system 100 of FIG. 1.

As shown in FIG. 2, the device 200 can include a bus system 202, which supports communication between at least one processing device 204, at least one storage device 206, at least one communications unit 208, at least one input/output (I/O) unit 210, and at least one display unit 212. The processing device 204 executes instructions that may be loaded into a memory 214. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 214 and a persistent storage 216 are examples of storage devices 206, which represent any structure(s) capable of storing and facilitating retrieval of information (such as data, program code, and/or other suitable information on a temporary or permanent basis). The memory 214 may represent a random access memory or any other suitable volatile or non-volatile storage device(s). The persistent storage 216 may contain one or more components or devices supporting longer-term storage of data, such as a read only memory, hard drive, flash memory, or optical disc. In accordance with this disclosure, the memory 214 and the persistent storage 216 may be configured to store instructions associated with creation of virtual representations of industrial assets.

The communications unit 208 supports communications with other systems, devices, or networks, such as the networks 110-120. For example, the communications unit 208 could include a network interface that facilitates communications over at least one Ethernet network. The communications unit 208 could also include a wireless transceiver facilitating communications over at least one wireless network. The communications unit 208 may support communications through any suitable physical or wireless communication link(s).

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

The display unit 212 can be used to present information to a user and to optionally receive input from a user. For example, the display module(s) 212 could include a display 218 and a touch screen 220 (which could be integrated into a single touch screen display). The display 218 could present a user interface (UI) that permits a user to interact with the device 200 and any software or programs being executed on the device 200. The touch screen 220 may capture user input when the user taps, slides, or otherwise touches the touch screen 220.

Although FIG. 2 illustrates one example of a device 200 for performing functions associated with three-dimensional visualization of industrial assets in a virtual environment, various changes may be made to FIG. 2. For example, various components in FIG. 2 could be combined, further subdivided, or omitted and additional components could be added according to particular needs. In addition, computing devices can come in a wide variety of configurations, and FIG. 2 does not limit this disclosure to any particular configuration of device.

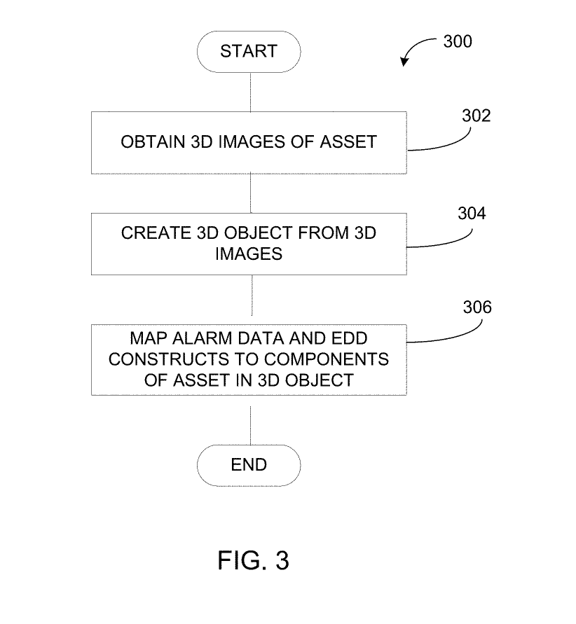

FIG. 3 illustrates an example method 300 for creating a virtual representation of an industrial asset according to this disclosure. For ease of explanation, the method 300 is described with respect to the device 200 of FIG. 2 operating in the system 100 of FIG. 1. More specifically, the processing device 204 of the device 200 can be used to execute one or more applications to perform the method 300. However, the method 300 could be used by any other suitable device and in any other suitable system.

As shown in FIG. 3, the device 200 obtains three-dimensional (3D) images or other information of an industrial asset and its corresponding components in step 302. The 3D images may be obtained from the asset vendor or manufacturer via a recording medium, such as a compact disc (CD), digital versatile disc (DVD), or Flash drive. In some embodiments, the 3D images may be obtained over a network, such as the Internet, from a server, such as a cloud server. In other embodiments, the 3D images may be created by a user when the 3D images are not available from a vendor or manufacturer. The images can relate to any suitable aspects of an asset, such as an external appearance of the asset, mechanical features of the asset, or designs of printed circuit boards (PCBs) of the asset.

In step 304, the 3D images are compiled by the processing device 204 to create 3D “virtual” object of the asset and its corresponding components. In step 306, a user may map alarm data and asset data, such as enhanced device description (EDD) data (which includes interface program (UIP), charts, graphs, grids, variables, and the like) to the 3D object using the device 200 to create a virtual representation of the asset.

Although FIG. 3 illustrates one example of a method 300 for creating a virtual representation of an industrial asset, various changes may be made to FIG. 3. For example, while shown as a series of steps, various steps in FIG. 3 could overlap, occur in parallel, occur in a different order, or occur any number of times.

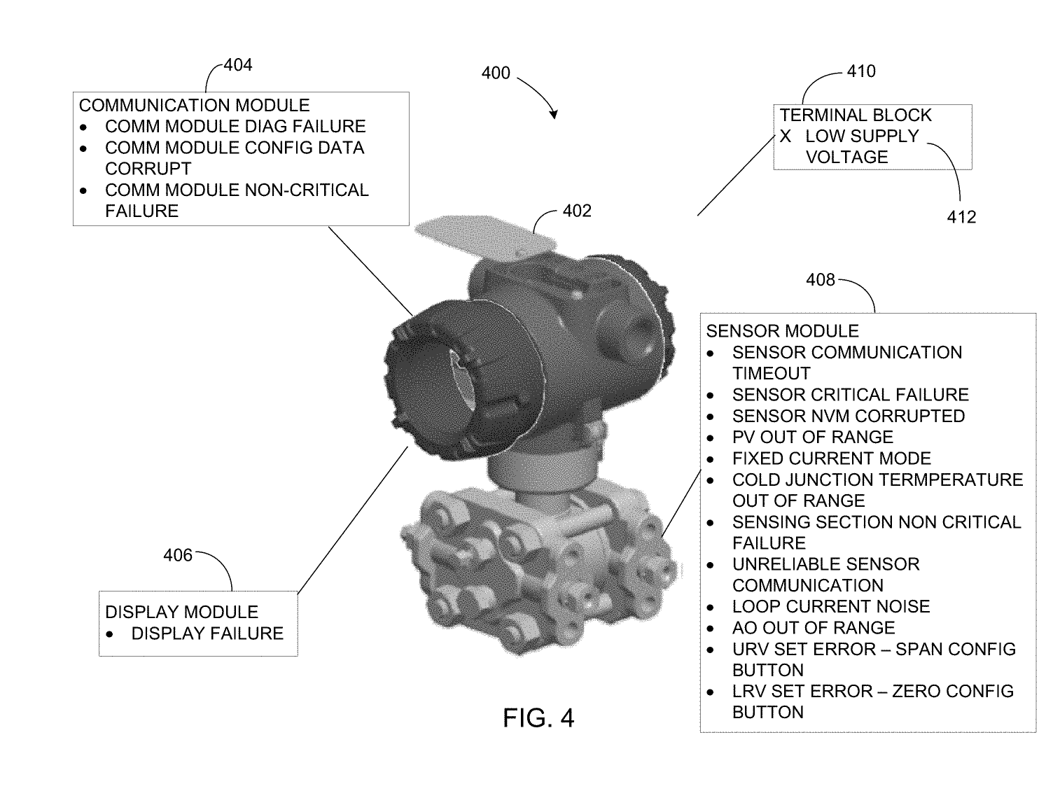

FIG. 4 illustrates an example virtual representation 400 of an industrial asset and its corresponding information according to this disclosure. For ease of explanation, the virtual representation 400 is described with respect to the device 200 of FIG. 2 operating in the system 100 of FIG. 1. More specifically, the virtual representation 400 is a representation of an industrial asset, such as sensor, actuator, controller, I/O module, or any other component of a system that may be displayed on a user interface presented on the display 218. The virtual representation 400 may be edited or manipulated by a user using the touch screen 220, the I/O unit 210, or other input mechanism. Such manipulation may include rotating, panning, or zooming.

As shown in FIG. 4, the virtual representation 400 includes a graphic 402 representing an industrial asset and information blocks 404, 406, 408, and 410. In this example, the information blocks 404-408 may display a number of possible alarms associated with their respective components, while the information block 410 displays a possible alarm associated with the industrial asset. In other embodiments, the information blocks 404-410 may display EDD data or media, such as pictures, animations, or videos. As seen in FIG. 4, information block 410 displays an indication that a low supply voltage alarm 412 has been triggered.

Although FIG. 4 illustrates one example of a virtual representation 400 of an industrial asset and its corresponding information, various changes may be made to FIG. 4. For example, a virtual representation could include any other or additional graphic(s) associated with an industrial asset. A virtual representation could also include any number of related information blocks depending on the alarm data and EDD data mapped to the industrial asset and its components.

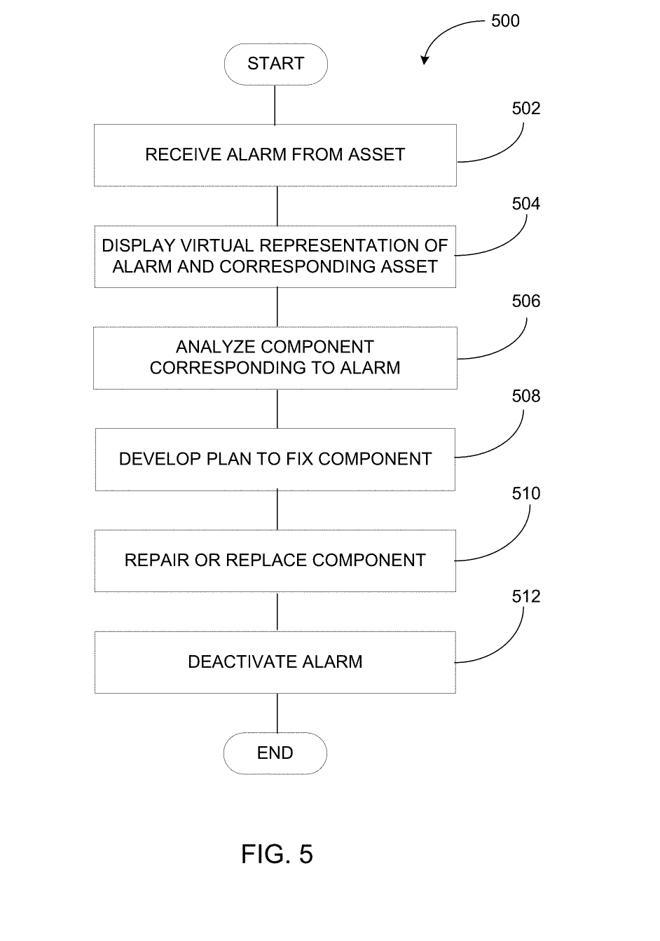

FIG. 5 illustrates an example method 500 for resolving an alarm according to this disclosure. For ease of explanation, the method 500 is described with respect to the virtual representation 400 of FIG. 4 that may be presented on device 200 of FIG. 2 operating in the system 100 of FIG. 1.

As shown in FIG. 5, the device 200 receives an alarm from an asset, such as a sensor, actuator, controller, I/O module, or any other component of system 100, in step 502. In step 504, the device 200 presents a virtual representation 400 of the asset that triggered the alarm on a display 218. In step 506, the user may edit or manipulate the virtual representation 400, such as by using a touch screen 220 or an I/O unit 210, to analyze the component of the asset corresponding to the alarm. For example, the user may zoom in on the asset to view components or sub-components that would trigger a low supply voltage alarm 412.

In step 508, the user may develop a plan to fix the defective industrial asset. In one example, a user may select one or more components from the virtual representation as component(s) that may need to be replaced using the touch screen 220, the I/O unit 210, or other input mechanism. The device 200 may then communicate with a vendor over a network using the communications unit 208 to place an order for the selected component(s). Further, a user may be able to determine the tools necessary to fix the issue that triggered the alarm and order the correct tool, if necessary. This will reduce the cycle time of maintenance activities and allow the customers/users to plan for the fixes in the control room itself. In step 510, the defective components are repaired or replaced, and the alarm is deactivated in step 512. In one example, the alarm may be deactivated by a user providing an input on the asset or device 200 indicating that the alarm has been resolved. In another example, the asset being repaired may provide an indication that the asset is functioning normally, thereby deactivating the alarm.

Although FIG. 5 illustrates one example of a method 500 for resolving an alarm, various changes may be made to FIG. 5. For example, while shown as a series of steps, various steps in FIG. 5 could overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc, a digital video disc, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, e.g., a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. An apparatus comprising:
at least one processing device configured to:
receive alarms following a first alarm from an industrial asset,
generate a three-dimensional (3D) virtual object corresponding to the industrial asset;
map data to the 3D virtual object to generate a virtual representation of the industrial asset;
wherein the said data comprises at least one of a first alarm associated with the industrial asset and information associated with the industrial asset, and a display configured to display the virtual representation.

2. The apparatus of claim 1, wherein the at least one processing device is configured to generate the 3D virtual object using at least one image of the industrial asset.

3. The apparatus of claim 1, wherein:
the at least one processing device is configured to generate the virtual representation identifying multiple sub-components of the industrial asset; and
the at least one processing device is configured to map the data to different sub-components of the industrial asset.

4. The apparatus of claim 1, further comprising:
an interface configured to receive information identifying a manipulation of the virtual representation.

5. The apparatus of claim 1, wherein the at least one processing device is further configured to edit or manipulate the virtual representation based on input received from a user.

6. The apparatus of claim 2, further comprising:
a communication unit configured to receive the at least one image.

7. (canceled)

8. The apparatus of claim 1, wherein the at least one processing device is further configured to:
display the virtual representation with the alarms following the first alarm.

9. A method comprising:
receiving alarms following a first alarm from an industrial asset,
generating a three-dimensional (3D) virtual object corresponding to an industrial asset;
mapping data to the 3D virtual object to generate a virtual representation of the industrial asset;
wherein the said data comprises at least one of a first alarm associated with the industrial asset and information associated with the industrial asset, and displaying the virtual representation on a display.

10. The method of claim 9, wherein the 3D virtual object is generated using at least one image of the industrial asset.

11. The method of claim 9, wherein:
the virtual representation identifies multiple sub-components of the industrial asset; and
the data is mapped to different sub-components of the industrial asset.

12. The method of claim 9, further comprising:
editing or manipulating the virtual representation based on input received from a user.

13. (canceled)

14. The method of claim 9, further comprising:
displaying the virtual representation with the alarms following the first alarm.

15. A non-transitory computer readable medium containing computer readable program code that, when executed by at least one processing device, causes the at least one processing device to:
receive alarms following a first alarm from an industrial asset,
generate a three-dimensional (3D) virtual object corresponding to an industrial asset;
map data to the 3D virtual object to generate a virtual representation of the industrial asset;
wherein the said data comprises at least one of a first alarm associated with the industrial asset and information associated with the industrial asset, and display the virtual representation.

16. The non-transitory computer readable medium of claim 15, wherein the 3D virtual object is generated using at least one image of the industrial asset.

17. The non-transitory computer readable medium of claim 15, wherein:
the virtual representation identifies multiple sub-components of the industrial asset; and
the data is mapped to different sub-components of the industrial asset.

18. The non-transitory computer readable medium of claim 15, further containing computer readable program code that, when executed by the at least one processing device, causes the at least one processing device to:
edit or manipulate the virtual representation based on input received from a user.

19. (canceled)

20. The non-transitory computer readable medium of claim 15, further containing computer readable program code that, when executed by the at least one processing device, causes the at least one processing device to:
display the virtual representation with the alarms following the first alarm.
